(19) United States
(12) Patent Application Publication
(10) Pub. No.: US 2024/0120588 A1
(43) Pub. Date: Apr. 11, 2024

(54) BATTERY CELL CARTRIDGE, BATTERY MODULE ASSEMBLY INCLUDING THE SAME, AND BATTERY PACK ASSEMBLY INCLUDING THE SAME

(71) Applicants: Hyundai Motor Company, Seoul (KR); Kia Corporation, Seoul (KR); Valeo Kapec Co., Ltd., Daegu (KR)

(72) Inventors: Hyunchang KANG, Seoul (KR); Jun Seok Chol, Hwaseong-Si (KR); Ji Woong Han, Daegu (KR); Wan Chol, Daegu (KR); Houk Park, Daegu (KR); Jae Eun Kim, Daegu (KR)

(73) Assignees: Hyundai Motor Company, Seoul (KR); Kia Corporation, Seoul (KR); Valeo Kapec Co., Ltd., Daegu (KR)

(21) Appl. No.: 18/223,683

(22) Filed: Jul. 19, 2023

(30) Foreign Application Priority Data
Oct. 6, 2022 (KR) 10-2022-0127967

(51) Int. Cl. H01M 50/202; H01M 50/262

(52) U.S. Cl. CPC H01M 50/202; H01M 50/262

(57) ABSTRACT

A battery cell cartridge in which a battery cell is accommodated, includes first, second, third and fourth frames formed in a quadrangular shape, wherein the first frame and the second frame extend along a horizontal direction and are spaced from each other at a predetermined interval therebetween, the first frame is positioned on an upper side and the second frame is positioned on a lower side, the third frame and the fourth frame extend along a vertical direction and are spaced from each other at a predetermined interval therebetween, and the third frame is positioned on a first side and the third frame is positioned on a second side opposite to the second frame.

### CROSS-REFERENCE TO RELATED APPLICATION(S)

The present application claims priority to Korean Patent Application No. 10-2022-0127967, filed on Oct. 6, 2022, the entire contents of which is incorporated herein for all purposes by this reference.

### BACKGROUND OF THE PRESENT DISCLOSURE

### Field of the Present Disclosure

The present disclosure relates to a battery cell cartridge, a battery module assembly including the same, and a battery pack assembly including the same.

### Description of Related Art

As technology development and demand for mobile devices increase, demand for secondary batteries as an energy source is rapidly increasing, and nickel cadmium batteries or hydrogen ion batteries have been generally used as conventional secondary batteries, but recently, lithium ion batteries and lithium polymer batteries having high energy densities have been widely used.

As for such a secondary battery, a lithium secondary battery with high output and capacity compared to weight using lithium transition metal oxide, lithium composite oxide, etc., as a cathode active material is greatly in the spotlight. In general, a lithium secondary battery has a structure in which an electrode assembly of a positive electrode/separator/negative electrode is embedded in a sealed container together with an electrolyte.

Lithium secondary batteries consist of a positive electrode, a negative electrode, a separator interposed therebetween, and an electrolyte, and are classified into a lithium ion battery (LIB), a polymer lithium ion battery (PLIB), and the like, depending on which positive and negative active materials are used. In general, the electrodes of these lithium secondary batteries are formed by coating a positive electrode or negative electrode active material on a current collector such as an aluminum or copper sheet, mesh, film, and foil, and then drying the electrode.

In a secondary battery module, a slave type BMS providing data on voltage/temperature of individual cells is applied to the module side, and for example, in the case of a secondary battery pack for automobiles, a BMS in the form of a master is provided at an upper stage such as a PCS or BMM to comprehensively manage functions of the entire secondary battery pack.

According to a related art, because there are various secondary battery modules, and structures and locations of a cartridge forming the module and a bus bar for sensing are different, an efficient connection work is difficult, the welding quality of a sensing structure deteriorates, and an unnecessary space of the secondary battery module needs to be provided for welding or the like, so that finally, the energy density of the secondary battery module may decrease.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a battery cell cartridge including a structure configured for being stacked in a stable form.

Various aspects of the present disclosure are directed to providing a battery module assembly including a structure configured for preventing separation of a sensing block and a side cover.

Various aspects of the present disclosure are directed to providing a battery pack assembly including a structure configured for coupling a plurality of battery module assemblies.

Additional aspects of the present disclosure will be set forth in part in the description which follows, and in part, will be obvious from the description, or may be learned by practice of the present disclosure.

In accordance with an aspect of the present disclosure, a battery cell cartridge, in which a battery cell is accommodated, includes first, second, third and fourth frames formed in a quadrangular shape, wherein the first frame and the second frame extend along a horizontal direction and are spaced from each other at a predetermined interval therebetween, the first frame is positioned on an upper side and the second frame is positioned on a lower side, the third frame and the fourth frame extend along a vertical direction and are spaced from each other at a predetermined interval therebetween, and the third frame is positioned on a first side and the third frame is positioned on a second side opposite to the second frame.

The battery cell cartridge may further include a plurality of pillars extending along the vertical direction to connect the first frame and the second frame between the third frame and the fourth frame based on the horizontal direction, wherein an adhesive may be attached to a pillar positioned adjacent to the third frame or the fourth frame among the plurality of pillars.

A first embossed portion including a protruding shape and a first recessed portion including a concave shape may be formed on a first surface of a front side of the first frame, a second embossed portion including a protruding shape and a second recessed portion including a concave shape may be formed on a second surface of a rear side of the first frame, the second recessed portion may be formed on a rear side of the first embossed portion based on the stacking direction on the second surface, and the second embossed portion may be formed on a rear side of the first recessed portion based on the stacking direction on the second surface.

A sensing block coupler including a guiding groove may be formed at each of opposite end portions of the first frame.

A seating protrusion protruding upward may be formed on the first frame to form a recessed portion at a predetermined distance from the sensing block coupler.

A lower support extending in the horizontal direction may be formed on a lower end portion of the second frame.

A third embossed portion including a protruding shape and a third recessed portion including a concave shape may be formed on a first surface of a front side of the lower support, and a fourth embossed portion including a protruding shape and a fourth recessed portion including a concave shape may be formed on a second surface of a rear side of the lower support.

In accordance with another aspect of the present disclosure, a battery module assembly includes a plurality of battery cell cartridges provided to stacked and assembled according an exemplary embodiment of the present disclosure, a battery cell accommodated in the battery cell cartridge, a sensing block provided on a side of the plurality of stacked cell cartridges, and a side cover provided on the sensing block to protect the sensing block thereby.

A guiding groove may be formed at an upper end portion of the battery cell cartridge, and a guiding protrusion provided to be inserted into the guiding groove may be formed on an upper surface of the sensing block.

A hole may be formed on a side of the battery cell cartridge, and a protrusion provided to be inserted into the hole may be formed on a rear surface of the sensing block.

The hole may be formed on each of upper and lower portions of the side of the battery cell cartridge, and the protrusion may be formed on each of upper and lower portions of the rear surface of the sensing block.

A snap-fit portion acting as a locking jaw for preventing the sensing block from being separated from the first frame may be formed at an upper portion of the sensing block.

A snap-fit portion acting as a locking jaw for preventing the side cover from being separated from the sensing block may be formed at an upper end portion of the side cover.

A snap-fit portion acting as a locking jaw for preventing the side cover from being separated from the sensing block may be formed at a lower end portion of the side cover.

The one battery cell may be disposed between the two adjacent battery cell cartridges, and when the plurality of battery cell cartridges is provided as N numbers, a plurality of battery cells may be provided as 2N numbers.

The two sensing blocks may be provided to be provided on opposite sides of the plurality of stacked battery cell cartridges, respectively.

The two side covers may be provided to be provided on the two sensing blocks, respectively, in a state in which the two sensing blocks are coupled to the battery cell cartridges.

In accordance with another aspect of the present disclosure, a battery pack assembly includes a plurality of battery module assemblies provided to stacked on each other according an exemplary embodiment of the present disclosure, an upper support bar provided on upper end portions of the battery module assemblies along a direction in which the battery module assemblies are stacked, and a lower support bar provided on lower end portions of the battery module assemblies along the direction in which the battery module assemblies are stacked.

A bent portion may be formed to be bent downward at a front end portion and a rear end portion of the upper support bar to couple the stacked battery module assemblies, and a recessed portion in which the upper support bar is accommodated may be provided at an upper end portion of each of the stacked battery module assemblies.

A bent portion may be formed to be bent upward at a front end portion and a rear end portion of the lower support bar to couple the stacked battery module assemblies, and a locking jaw in which the lower support bar is accommodated may be provided at a lower end portion of each of the stacked battery module assemblies.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a perspective view exemplarily illustrating a battery cell cartridge according to an exemplary embodiment of the present disclosure;

FIG. 2 is a front view exemplarily illustrating the battery cell cartridge according to an exemplary embodiment of the present disclosure;

FIG. 3 is a perspective view exemplarily illustrating that the battery cell cartridges illustrated in FIG. 2 are stacked together with battery cells:

FIG. 4 is a perspective view exemplarily illustrating a battery module assembly according to an exemplary embodiment of the present disclosure;

FIG. 5 is a perspective view exemplarily illustrating that sensing blocks are provided on the stacked battery cell cartridges in the battery module assembly illustrated in FIG. 4:

FIG. 6 is an enlarged view of a portion A shown in FIG. 5;

FIG. 7 is an enlarged view of a portion B shown in FIG. 5:

FIG. 8 is a perspective view exemplarily illustrating that side covers are provided on the sensing blocks in the battery module assembly illustrated in FIG. 4;

FIG. 9 is an enlarged view of a portion C shown in FIG. 8:

FIG. 10 is an enlarged view of a portion D shown in FIG. 8;

FIG. 11 is a perspective view exemplarily illustrating a battery pack assembly according to an exemplary embodiment of the present disclosure;

FIG. 12 is a perspective view exemplarily illustrating an upper support bar illustrated in FIG. 11;

FIG. 13 is an enlarged view of a portion E shown in FIG. 11; and

FIG. 14 is an enlarged view of a portion F shown in FIG. 11.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, an exemplary embodiment of the present disclosure will be described in detail with reference to the accompanying drawings. The exemplary embodiment described below is provided by way of example so that those skilled in the art will be able to fully understand the spirit of the present disclosure. The present disclosure is not limited to the exemplary embodiment described below, but may be embodied in other forms. To clearly explain the present disclosure, parts not related to the description are omitted from the drawings, and sizes of components may be exaggerated for convenience.

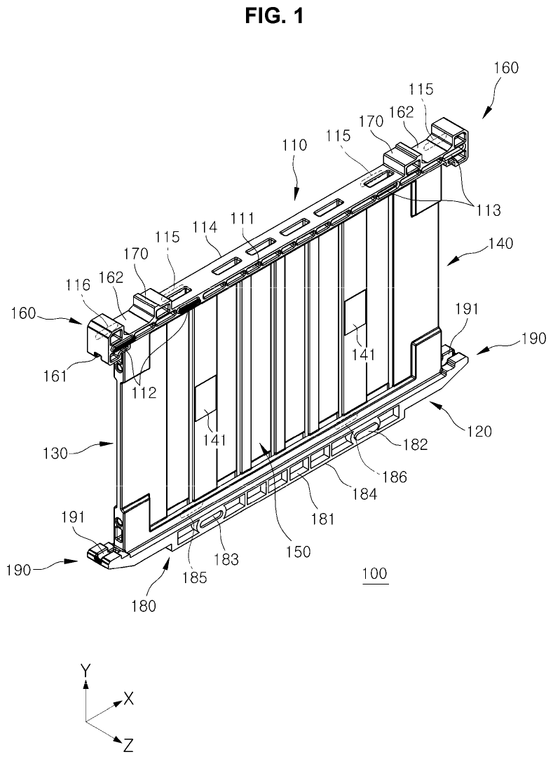

In coordinate axes illustrated in FIGS. 1 to 14, an X axis represents a ‘horizontal direction’, a Y axis represents a ‘vertical direction, and a Z axis represents a ‘stacking direction’.

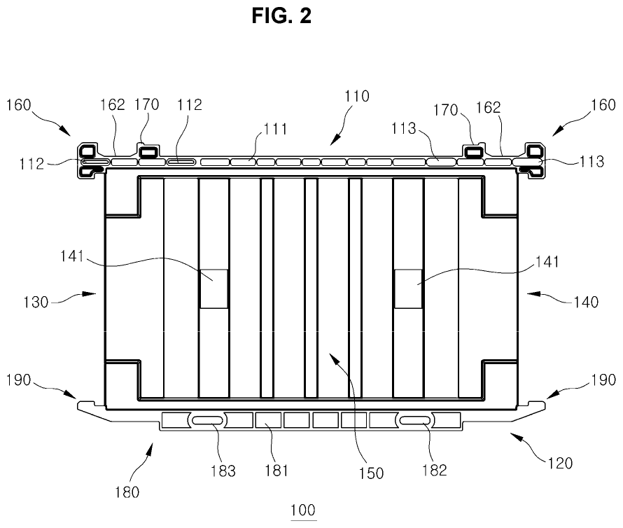

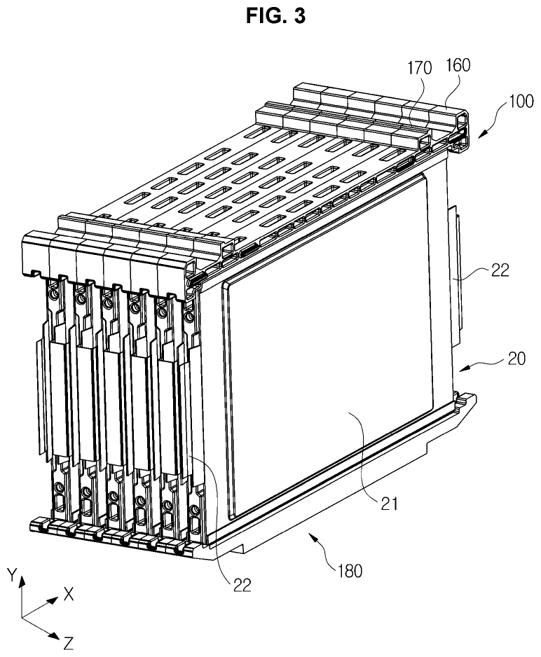

FIG. 1 is a perspective view exemplarily illustrating a battery cell cartridge according to an exemplary embodiment of the present disclosure. FIG. 2 is a front view exemplarily illustrating the battery cell cartridge according to an exemplary embodiment of the present disclosure. FIG. 3 is a perspective view exemplarily illustrating that the battery cell cartridges illustrated in FIG. 2 are stacked together with battery cells.

A battery cell cartridge 100 may be configured in a form of a frame for seating battery cells 20 thereon. The battery cell cartridge 100 may be made of, for example, a synthetic resin material. The battery cell 20 may include a cell body 21 and an electrode lead 22 (cell tab). Two of the electrode leads 22 may be provided on opposite sides of the cell body 21 to indicate positive and negative poles.

The battery cell cartridge 100 may include a first frame 110 extending in a horizontal direction, a second frame 120 spaced from the first frame 110 at a predetermined interval and extending in the horizontal direction, a third frame 130 extending in a vertical direction to connect one end portions of the first frame 110 and the second frame 120, a fourth frame 140 extending in the vertical direction to connect the other end portions of the first frame 110 and the second frame 120, and a plurality of pillars 150 extending along the vertical direction to connect the first frame 110 and the second frame 120 between the third frame 130 and the fourth frame 140.

An adhesive 141 may be attached to a pillar positioned adjacent to the third frame 130 or the fourth frame 140 among the plurality of pillars 150. The adhesive 141 may have, for example, a double-sided tape. The battery cell 20 may be fixed to the battery cell cartridge 100 through the adhesive 141.

Also, two of the battery cells 20 may be coupled to opposite sides of one of the battery cell cartridges 100. Therefore. N numbers of the battery cell cartridges 100 may be required to stack 2N numbers of the battery cells 20, wherein the N is a positive integer number. That is, in the exemplary embodiment of the present disclosure, 2N numbers of the battery cells may be provided on N numbers of the battery cell cartridges.

The battery cell cartridges 100 may be manufactured in one type, and may even serve as outermost covers. A rib structure for fastening the plurality of battery cell cartridges 100 may be provided to the first frames 110 and the second frames 120.

A plurality of battery cell cartridges 100 may be provided, and a structure for coupling the battery cell cartridges 100 to each other may be provided. A first embossed portion 112 including a protruding shape and a first recessed portion 113 including a concave shape may be formed on a first surface 111 of a front side of the first frame 110, and a second embossed portion 115 including a protruding shape and a second recessed portion 116 including a concave shape may be formed on a second surface 114 of a rear side of the first frame 110. The second recessed portion 116 may be formed on the opposite side of the first embossed portion 112 based on the stacking direction, and the second embossed portion 115 may be formed on the opposite side of the first recessed portion 113 based on the stacking direction thereof.

Referring to FIG. 3, based on the two adjacent battery cell cartridges 100, the first embossed portion 112 of the battery cell cartridge 100 positioned at the rear may be inserted into the second recessed portion 116 of the battery cell cartridge 100 positioned at the front, and the first recessed portion 113 of the battery cell cartridge 100 positioned at the rear may be inserted into the second embossed portion 115 of the battery cell cartridge 100 positioned at the front.

A sensing block coupler 160 including a guiding groove 161 may be formed at each of opposite end portions of the first frame 110. Furthermore, a seating protrusion 170 protruding upward may be formed on the first frame 110 to form a recessed portion 162 at a predetermined distance from the two sensing block couplers 160.

A lower support 180 extending in the horizontal direction may be formed at a lower end portion of the second frame 120. A third embossed portion 182 including a protruding shape and a third recessed portion 183 including a concave shape may be formed on a first surface 181 of a front side of the lower support 180, and a fourth embossed portion 185 including a protruding shape and a fourth recessed portion 186 including a concave shape may be formed on a second surface 184 of a rear side of the lower support 180. Therefore, the lower support 180 positioned on the front side and the lower support 180 positioned on the rear side with respect to the two adjacent battery cell cartridges 100 may include a structure of being coupled to each other.

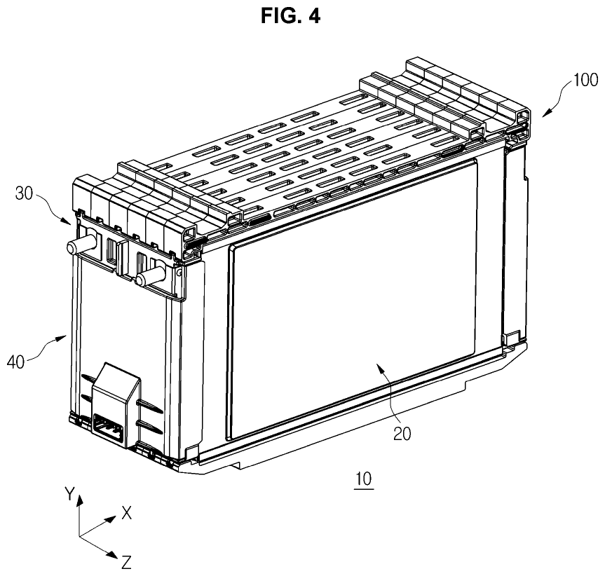

FIG. 4 is a perspective view exemplarily illustrating a battery module assembly according to an exemplary embodiment of the present disclosure.

The battery module assembly 10 may include a plurality of battery cell cartridges 100 mounted to be stacked on each other, a plurality of battery cells 20 accommodated in the battery cell cartridges 100, a sensing block 30 provided on a side of the plurality of stacked cell cartridges 100, and a side cover 40 provided on the sensing block 30 to protect the sensing block 30. Preventing the movement of the battery cells 20 in the stacking direction may be achieved by both the sensing block 30 and the side cover 40. Because the battery cell cartridges 100, which are units forming the battery module assembly 10, all include a same structure, manufacturing efficiency may be increased.

Referring to FIG. 3 and FIG. 4, one of the battery cells 20 may be disposed between the two adjacent battery cell cartridges 100. Because the one battery cell 20 is disposed between the two adjacent battery cell cartridges 100, when the plurality of battery cells 20 is provided as 2N numbers, the plurality of battery cell cartridges 100 may be provided as N numbers. That is, referring to FIG. 3, FIG. 3 illustrates an exemplary embodiment in which twelve electrode leads and six cartridges are provided, and thus, in the exemplary embodiment of the present disclosure, two battery cells are provided per one battery cell cartridge.

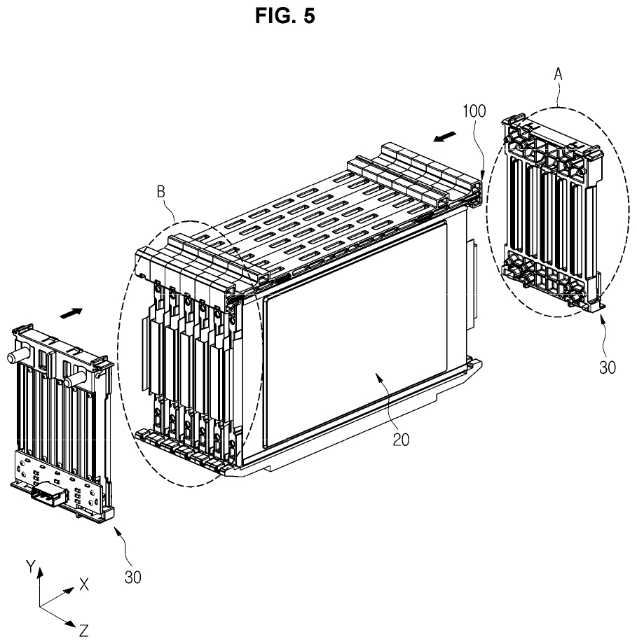

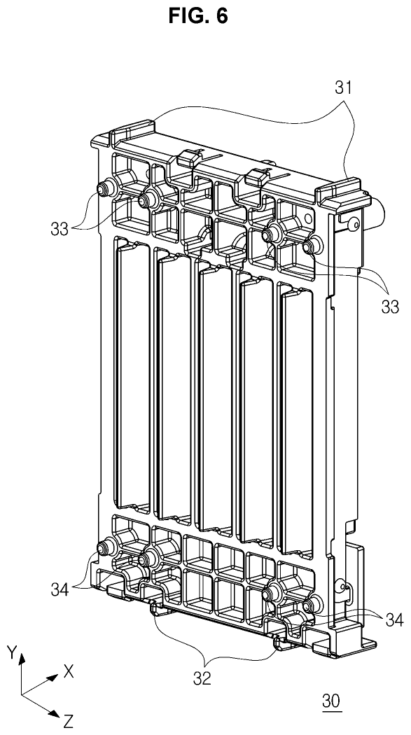

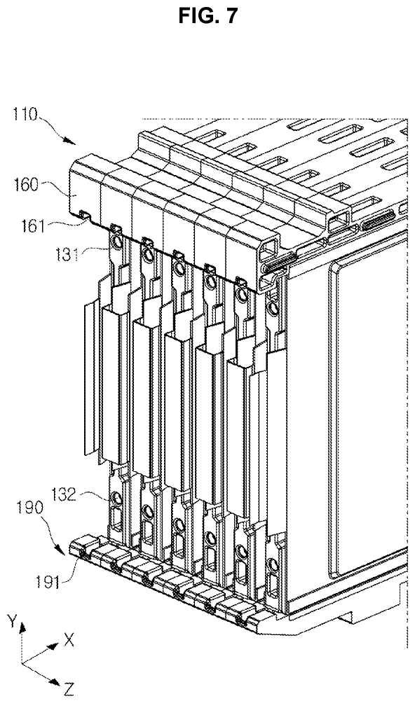

FIG. 5 is a perspective view exemplarily illustrating that sensing blocks are provided on the stacked battery cell cartridges in the battery module assembly illustrated in FIG. 4. FIG. 6 is an enlarged view of part A illustrated in FIG. 5. FIG. 7 is an enlarged view of part B illustrated in FIG. 5.

FIG. 5 and FIG. 7 illustrate that the adjacent electrode leads 22 overlap each other in a state in which the sensing blocks 30 are removed, for convenience of description. Similarly, FIG. 3 illustrates that the adjacent electrode leads 22 overlap each other in the state in which the sensing blocks 30 are removed. The electrode leads 22 are folded to overlap over sensing terminals provided on the sensing block 30 after passing through slots provided on the sensing block 30, and then three sheets may be welded to form a triple structure in which the sensing terminals and the electrode leads are overlapped and connected.

Referring to FIG. 5, the sensing blocks 30 may be provided as two pieces to be respectively provided on opposite sides of the plurality of stacked battery cell cartridges 100.

Referring to FIG. 6 and FIG. 7, guiding grooves 161 and 191 may be formed at upper and lower end portions of the battery cell cartridge 100, and guiding protrusions 31 and 32 provided to be inserted into the guiding grooves 161 and 191 may be formed on the sensing block 30. The sensing block coupler 160 including the guiding groove 161 may be formed in the first frame 110, and a sensing block coupler 190 including the guiding groove 191 formed on the second frame 120.

The guiding protrusion 31 provided on the upper side of the sensing block 30 may be inserted into the guiding groove 161 formed on the first frame 110, and the guiding protrusion 32 provided on the lower side of the sensing block 30 may be inserted into the guiding groove 191 formed on the second frame 120.

According to an exemplary embodiment of the present disclosure, the guiding grooves for accommodating the guiding protrusions formed on the sensing blocks are formed at upper and lower portions of a side of each of the battery cell cartridges, so that movement of the cartridges in the stacking direction may be prevented.

Referring to FIG. 6 and FIG. 7, holes 131 and 132 may be formed on a side of the battery cell cartridge 100, that is, the third frame 130 and the fourth frame 140, and protrusions 33 and 34 provided to be inserted into the holes 131 and 132 may be formed on a rear surface of the sensing block 30. That is, the holes 131 and 132 may be formed at upper and lower portions of the side of the battery cell cartridge 100, respectively, and the protrusions 33 and 34 may be respectively formed at upper and lower portions of the rear surface of the sensing block 30, respectively.

A snap-fit portion 35 acting as a locking jaw for preventing the sensing block 30 from being separated from the first frame 110 may be formed at an upper portion of the sensing block 30. That is, the snap-fit portion 35 acts as a locking jaw after passing through a lower surface of the sensing block coupler 160, so that separation of the sensing block 30 may be prevented.

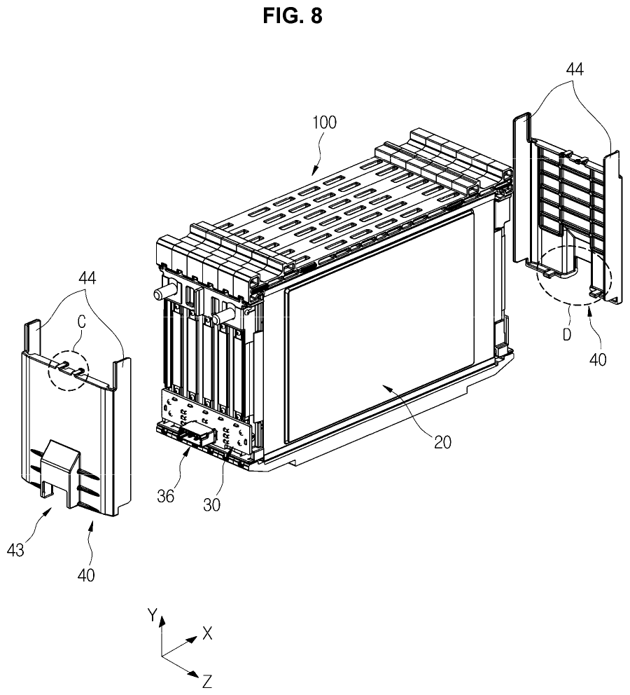

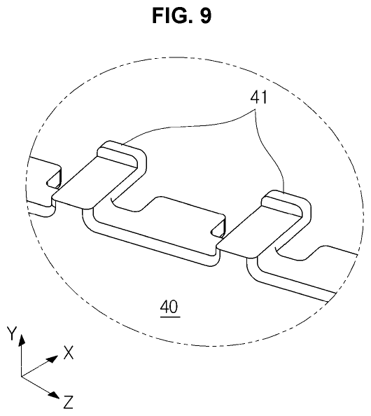

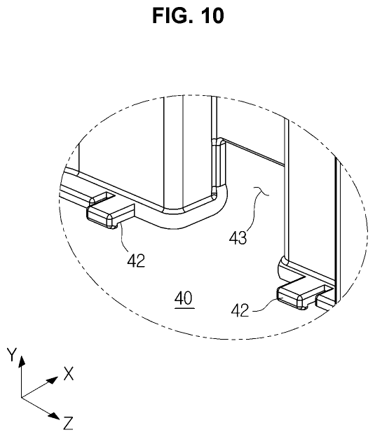

FIG. 8 is a perspective view exemplarily illustrating that side covers are provided on the sensing blocks in the battery module assembly illustrated in FIG. 4. FIG. 9 is an enlarged view of part C illustrated in FIG. 8. FIG. 10 is an enlarged view of part D illustrated in FIG. 8.

Referring to FIG. 8, the two side covers 40 may be provided to be provided on the two sensing blocks 30, respectively, in a state in which the two sensing blocks 30 are coupled to the battery cell cartridges 100. An accommodating portion 43 may be formed on the side cover 40 to expose a connector 36 provided on the sensing block 30 to the outside.

A wing extension portion 44 may be formed on the side cover 40 to restrict movement of one of the battery cell cartridges 100 disposed at the outermost position thereof. The side cover 40 has snap-fit portions 41 and 42 at upper and lower end portions, respectively, to hold the outermost battery cell cartridge while being coupled to the sensing block 30. Alternatively, a method in which the side cover 40 simply is configured as a cover without holding the outermost battery cell cartridge is also possible.

Referring to FIG. 9, the snap-fit portion 41 acting as a locking jaw for preventing the side cover 40 from being separated from the sensing block 30 may be formed at the upper end portion of the side cover 40. Referring to FIG. 10, the snap-fit portion 42 acting as a locking jaw for preventing the side cover 40 from being separated from the sensing block 30 may be formed at the lower end portion of the side cover 40. The snap-fit portion 42 may be formed on opposite sides of the accommodating portion 43.

According to an exemplary embodiment of the present disclosure, the number of types of portions forming the battery module assembly may be reduced and the structure may be simplified.

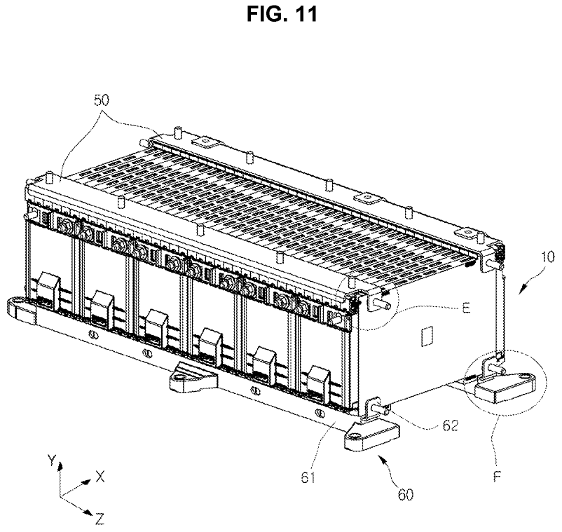

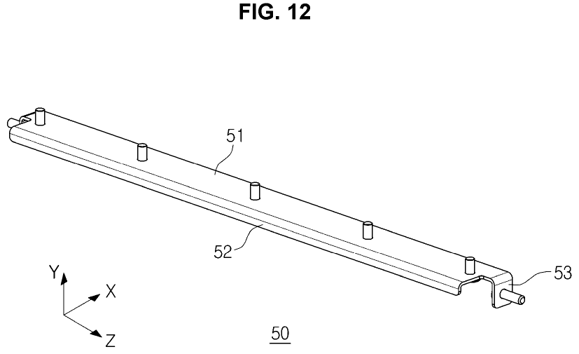

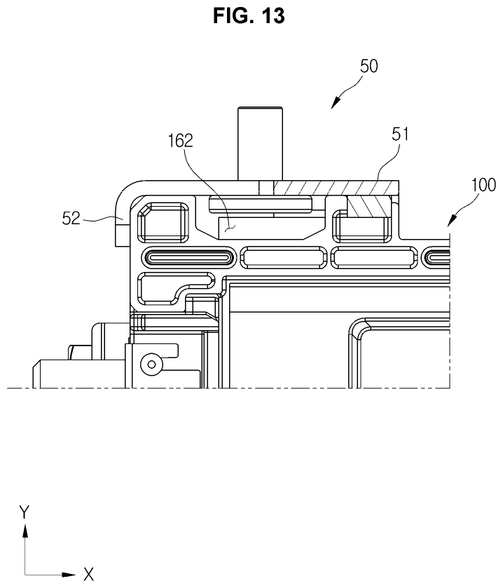

FIG. 11 is a perspective view exemplarily illustrating a battery pack assembly according to an exemplary embodiment of the present disclosure. FIG. 12 is a perspective view exemplarily illustrating an upper support bar illustrated in FIG. 11. FIG. 13 is an enlarged view of part E illustrated in FIG. 11.

A battery pack assembly 1 may include a plurality of battery module assemblies 10 provided to be stacked on each other, an upper support bar 50 provided on upper end portions of the battery module assemblies 10 along the direction in which the battery module assemblies 10 are stacked, and a lower support bar 60 provided on lower end portions of the battery module assemblies 10 along the direction in which the battery module assemblies 10 are stacked. The battery pack assembly 1 is an assembly of the largest unit finally completed before actually being assembled in a vehicle. A recessed structure for accommodating the upper and lower support bars forming the battery pack assembly (BPA) may be formed at the upper and lower end portions of each of the battery cell cartridges.

The upper support bar 50 may be made of a metal material and extend along the stacking direction of the battery module assemblies 10. The upper support bar 50 may include a body 51, a first bent portion 53 formed to be bent downwardly from a front end portion and a rear end portion of the body 51 to couple the stacked battery module assemblies 10, and a second bent portion 52 formed to be bent downwardly from sides of the body 51. The recessed portion 162 in which the upper support bar 50 is accommodated may be provided at each of the upper end portions of the plurality of stacked battery module assemblies 10.

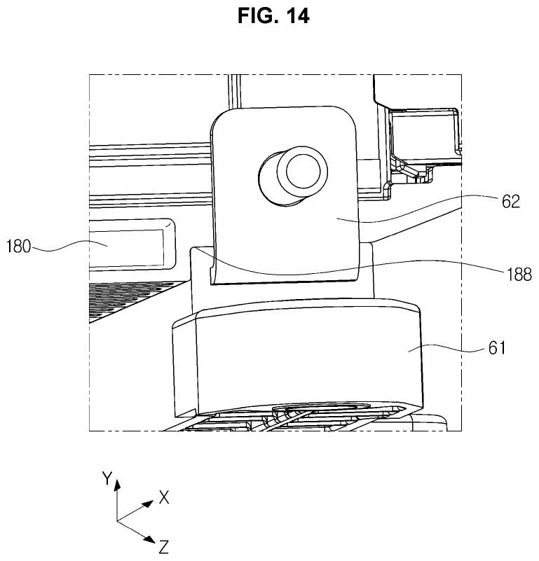

FIG. 14 is an enlarged view of part F illustrated in FIG. 11.

The lower support bar 60 may extend along the stacking direction of the battery module assemblies 10. The lower support bar 60 may include a body 61, and a bent portion 62 formed to be bent upwards from a front end portion and a rear end portion of the body 61 to couple the stacked battery module assemblies 10. A locking jaw 188 in which the lower support bar 60 is accommodated may be provided at a lower end portion of each of the stacked battery module assemblies 10.

According to an exemplary embodiment of the present disclosure, because the battery cell cartridges including the same shape are disposed and mounted between the respective battery cells, and the mounted cartridges are fixed through the coupling of the sensing blocks, the number of portions for forming the battery module assembly is minimized, and the battery module assemblies may be configured through a simple assembly process compared to conventional methods.

As is apparent from the above, according to an exemplary embodiment of the present disclosure, a plurality of cartridges may be stacked in a stable form by forming embossed portions and recessed portions at upper and lower end portions thereof.

According to an exemplary embodiment of the present disclosure, separation of a plurality of battery module assemblies may be prevented by forming snap-fit portions on a sensing block and a side cover.

According to an exemplary embodiment of the present disclosure, a battery pack assembly can couple the plurality of battery module assemblies by including an upper support bar and a lower support bar.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A battery cell cartridge, in which a battery cell is accommodated, the battery cell cartridge comprising:
first, second, third and fourth frames formed in a quadrangular shape,
wherein the first frame and the second frame extend along a horizontal direction and are spaced from each other at a predetermined interval therebetween,
wherein the first frame is positioned on an upper side and the second frame is positioned on a lower side,
wherein the third frame and the fourth frame extend along a vertical direction and are spaced from each other at a predetermined interval therebetween, and
wherein the third frame is positioned on a first side and the third frame is positioned on a second side opposite to the second frame.

2. The battery cell cartridge of claim 1, further including:
a plurality of pillars extending along the vertical direction to connect the first frame and the second frame between the third frame and the fourth frame based on the horizontal direction,
wherein an adhesive is attached to a pillar positioned adjacent to the third frame or the fourth frame among the plurality of pillars.

3. The battery cell cartridge of claim 1,
wherein a first embossed portion and a first recessed portion are formed on a first surface of a front side of the first frame,
wherein a second embossed portion and a second recessed portion are formed on a second surface of a rear side of the first frame,
wherein the second recessed portion is formed on a rear side of the first embossed portion based on a stacking direction on the second surface, and
wherein the second embossed portion is formed on a rear side of the first recessed portion based on the stacking direction on the second surface.

4. The battery cell cartridge of claim 1, wherein a sensing block coupler including a guiding groove is formed at each of opposite end portions of the first frame.

5. The battery cell cartridge of claim 4, wherein a seating protrusion protruding upward is formed on the first frame to form a recessed portion at a predetermined distance from the sensing block coupler.

6. The battery cell cartridge of claim 1, wherein a lower support extending in the horizontal direction is formed on a lower end portion of the second frame.

7. The battery cell cartridge of claim 6,
wherein a third embossed portion and a third recessed portion are formed on a first surface of a front side of the lower support, and
wherein a fourth embossed portion and a fourth recessed portion are formed on a second surface of a rear side of the lower support.

8. A battery module assembly including:
the battery cell cartridge of claim 1, being in plural and provided to be stacked and mounted;
the battery cell accommodated in each of the plurality of battery cell cartridges;
a sensing block provided on a side of the plurality of stacked cell cartridges; and
a side cover provided on the sensing block to protect the sensing block thereby.

9. The battery module assembly of claim 8, further including:
a guiding groove formed at an upper end portion of each battery cell cartridge; and
a guiding protrusion formed on an upper surface of the sensing block and provided to be inserted into the guiding groove.

10. The battery module assembly of claim 8, further including:
a hole formed on a side of each battery cell cartridge, and
a protrusion formed on a rear surface of the sensing block and provided to be inserted into the hole.

11. The battery module assembly of claim 10,
wherein the hole is formed on each of upper and lower portions of the side of each battery cell cartridge, and
wherein the protrusion is formed on each of upper and lower portions of the rear surface of the sensing block.

12. The battery module assembly of claim 8, wherein a snap-fit portion acting as a locking jaw is formed at an upper portion of the sensing block for preventing the sensing block from being separated from the first frame.

13. The battery module assembly of claim 8, wherein a snap-fit portion acting as a locking jaw is formed at an upper end portion of the side cover for preventing the side cover from being separated from the sensing block.

14. The battery module assembly of claim 8, wherein a snap-fit portion acting as a locking jaw is formed at a lower end portion of the side cover for preventing the side cover from being separated from the sensing block.

15. The battery module assembly of claim 8,
wherein one battery cell is disposed between two adjacent battery cell cartridges among the plurality of battery cell cartridges, and
wherein when the plurality of battery cell cartridges is provided as N numbers, a plurality of battery cells is provided as 2N numbers, the N being a positive integer number.

16. The battery module assembly of claim 8, wherein two sensing blocks are provided to be provided on opposite sides of the plurality of stacked battery cell cartridges, respectively.

17. The battery module assembly of claim 16, wherein two side covers are provided on the two sensing blocks, respectively, in a state in which the two sensing blocks are coupled to the battery cell cartridges.

18. A battery pack assembly including:
the battery module assembly of claim 8, being in plural and provided to be stacked on each other;
an upper support bar provided on upper end portions of the plurality of battery module assemblies along a direction in which the plurality of battery module assemblies are stacked; and
a lower support bar provided on lower end portions of the plurality of battery module assemblies along the direction in which the plurality of battery module assemblies are stacked.

19. The battery pack assembly of claim 18, further including:
a bent portion formed to be bent downward at a front end portion and a rear end portion of the upper support bar to couple the stacked battery module assemblies thereby; and
a recessed portion provided at an upper end portion of each of the stacked battery module assemblies, wherein the upper support bar is accommodated in the recessed portion.

20. The battery pack assembly of claim 18, further including:
a bent portion formed to be bent upward at a front end portion and a rear end portion of the lower support bar to couple the stacked battery module assemblies thereby; and
a locking jaw provided at a lower end portion of each of the stacked battery module assemblies, wherein the lower support bar is accommodated in the locking jaw.
